(19) United States
(12) Patent Application Publication
(10) Pub. No.: US 2025/0062815 A1
(43) Pub. Date: Feb. 20, 2025

(54) UE-SIDE BEAM SELECTION PROCEDURE

(71) Applicant: Telefonaktiebolaget LM Ericsson (publ), Stockholm (SE)

(72) Inventors: Igor Moaco Guerreiro, Fortaleza (BR); Laszlon R. Costa, Juazeiro do Norte (BR); Anders Landstrom, Boden (SE); Arne Simonsson, Gammelstad (SE)

(21) Appl. No.: 18/721,037

(22) PCT Filed: Dec. 17, 2021
(86) PCT No.: PCT/SE2021/051281

§ 371 Date: Jun. 17, 2024

(51) Int. Cl. H04B 7/06; H04B 7/08; H04L 5/00

(52) U.S. Cl. CPC H04B 7/06952; H04B 7/086; H04L 5/0051

(57) ABSTRACT

There is provided mechanisms for assisting a UE-side beam selection procedure. A method is performed by a network node. The method comprises estimating TRP-side angular information of a CE from uplink signalling received from the UE at a TRP of the network node. The method comprises reporting the TRP-side angular 5 information towards the UE and configuring the UE to perform a UE-side beam selection procedure based on the TRP-side angular information.

### TECHNICAL FIELD

Embodiments presented herein relate to a method, a network node, a computer program, and a computer program product for assisting a UE-side beam selection procedure. Embodiments presented herein further relate to a method, a user equipment, a computer program, and a computer program product for performing a UE-side beam selection procedure.

### BACKGROUND

In communications networks, there may be a challenge to obtain good performance and capacity for a given communications protocol, its parameters and the physical environment in which the communications network is deployed.

For example, for future generations of mobile communications networks, frequency bands at many different carrier frequencies could be needed. For example, low such frequency bands could be needed to achieve sufficient network coverage for wireless devices and higher frequency bands (e.g. at millimeter wavelengths (mmW), i.e. near and above 30 GHz, or even frequency bands in the THz, or at least sub-THz region) could be needed to reach required network capacity. In general terms, at high frequencies the propagation properties of the radio channel are more challenging and beamforming both at the network node of the network and at the wireless devices might be required to reach a sufficient link budget.

FIG. 1 is a schematic diagram illustrating a communication network 100 according to an example. The communication network 100 could be a fourth generation (4G) telecommunications network, a fifth generation (5G) telecommunications network, or any evolvement thereof, and support any 3rd generation partnership project (3GPP) telecommunications standard, where applicable.

The communication network 100 comprises a network node 200 configured to provide network access to user equipment (UE), as represented by UE 300, in a radio access network 110. The radio access network 110 is operatively connected to a core network 120. The core network 120 is in turn operatively connected to a service network 130, such as the Internet. The UE 300 is thereby enabled to, via the network node 200, access services of, and exchange data with, the service network 130.

The network node 200 comprises, is collocated with, is integrated with, or is in operational communications with, a transmission and reception point (TRP) 140. The network node 200 (via its TRP 140) and the UE 300 is configured to communicate with each other over wireless links 190 in a radio propagation channel, or environment. Examples of network nodes 200 are radio access network nodes, radio base stations, base transceiver stations, Node Bs (NBs), evolved Node Bs (eNBs), gNBs, access points, access nodes, and integrated access and backhaul (IAB) nodes. Examples of UEs 300 are wireless devices, mobile stations, mobile phones, handsets, wireless local loop phones, smartphones, laptop computers, tablet computers, network equipped sensors, network equipped vehicles, and so-called Internet of Things devices.

Due to severe propagation losses, the radio propagation channel in such high frequency bands usually have a few useful paths, or even just the line of sight (LOS) path, for facilitating reliable communication between TRP at the network-side and a UE at the user-side. Large antenna arrays are then used to provide array gains large enough to overcome the propagation losses. However, large antenna arrays operating at higher frequency bands generally have only few radio-frequency (RF) chains due to hardware complexity. This allows only for the use of analog or hybrid beamforming. In this case, beams are narrow and time multiplexed, yielding a very large number of beams to be managed at both the network-side and the user-side.

In this context, beam management as used in new radio (NR) telecommunication systems, also referred to as 5G telecommunication systems, includes some procedures that are mainly responsible for i) establishing an initial beam pair link (BPL) between the TRP and the UE, and ii) maintaining the BPL with good quality. A beam refinement procedure can then be performed to improve link quality, for example by finding BPLs with beams (at both the TRP and the UE) that provide higher array gain and/or better spatial alignment than the initial BPL. However, in such higher frequency bands, large bandwidth and high throughput make session time short. Therefore, the beam refinement procedure must be fast to be useful. This will be further elaborated on with reference to FIG. 2. FIG. 2 schematically illustrates a beam management procedure, which is a typical example of a legacy NR beam management procedure, consisting of three sub-procedures, referred to as P-1, P-2, and P-3 sub-procedures. These three sub-procedures will now be disclosed in more detail.

One main purpose of the P-1 sub-procedure is for the network node 200 to find a coarse direction towards the UE 300 by transmitting reference signals in wide, but narrower than sector, beams that are swept over the whole angular sector. The TRP 140 is expected to, for the P-1 sub-procedure, utilize beams, according to a spatial beam pattern 150a, with rather large beam widths. During the P-1 sub-procedure, the reference signals are typically transmitted periodically and are shared between all UEs 300 served by the network node 200 in the radio access network 110. The UE 300 uses a wide, or even omni-directional beam for receiving the reference signals during the P-1 sub-procedure, according to a spatial beam pattern 172a. The reference signals might be periodically transmitted channel state information reference signals (CSI-RS) or synchronization signal blocks (SSB). The UE 300 might then to the network node 200 report the N≥1 best beams and their corresponding quality values, such as reference signal received power (RSRP) values. The beam reporting from the UE 300 to the network node 200 might be performed rather seldom (in order to save overhead) and can be either periodic, semi-persistent or aperiodic.

One main purpose of the P-2 sub-procedure is to refine the beam selection at the TRP 140 by the network node 200 transmitting reference signals whilst performing a new beam sweep with more narrow directional beams, according to a spatial beam pattern 160a, than those beams used during the P-1 sub-procedure, where the new beam sweep is performed around the coarse direction, or beam, reported during the P-1 sub-procedure. During the P-2 sub-procedure, the UE 300 typically uses the same beam as during the P-1 sub-procedure, according to a spatial beam pattern 172a. The UE 300 might then to the network node 200 report the N≥1 best beams and their corresponding quality values, such as reference signal received power (RSRP) values. One P-2 sub-procedure might be performed per each UE 300 or per each group of terminal devices 200. The reference signals might be aperiodically or semi-persistently transmitted CSI-RS. The P-2 sub-procedure might be performed more frequently than the P-1 sub-procedure in order to track movements of the UE 300 and/or changes in the radio propagation environment.

One main purpose of the P-3 sub-procedure is for UEs 300 utilizing analog beamforming, or digital wideband (time domain beamformed) beamforming, to find best beam. During the P-3 sub-procedure, the reference signals are transmitted, according to a spatial beam pattern 162a, in the best reported beam of the P-2 sub-procedure whilst the UE 300 performs a beam sweep, according to a spatial beam pattern 180a. The P-3 sub-procedure might be performed at least as frequently as the P-2 sub-procedure in order to enable the UE 300 to compensate for blocking, and/or rotation.

In general, the beam management is based on the transmission of reference signals (RSs) in different directional beams in a set of pre-specified intervals and directions to cover a spatial area. As the number of candidate BPLs to evaluate can be comparatively large, the beam refinement procedure might require longer time to be performed than desired.

Hence, there is still a need for improved beam selection procedures.

### SUMMARY

An object of embodiments herein is to provide efficient beam selection at the UE.

According to a first aspect there is presented a method for assisting a UE-side beam selection procedure. The method is performed by a network node. The method comprises estimating TRP-side angular information of a UE from uplink signalling received from the UE at a TRP of the network node. The method comprises reporting the TRP-side angular information towards the UE and configuring the UE to perform a UE-side beam selection procedure based on the TRP-side angular information.

According to a second aspect there is presented a network node for assisting a UE-side beam selection procedure. The network node comprises processing circuitry. The processing circuitry is configured to cause the network node to estimate TRP-side angular information of a UE from uplink signalling received from the UE at a TRP of the network node. The processing circuitry is configured to cause the network node to report the TRP-side angular information towards the UE and configuring the UE to perform a UE-side beam selection procedure based on the TRP-side angular information.

According to a third aspect there is presented a network node for assisting a UE-side beam selection procedure. The network node comprises an estimate module configured to estimate TRP-side angular information of a UE from uplink signalling received from the UE at a TRP of the network node. The network node comprises a report module configured to report the TRP-side angular information towards the UE and configuring the UE to perform a UE-side beam selection procedure based on the TRP-side angular information.

According to a fourth aspect there is presented a computer program for assisting a UE-side beam selection procedure, the computer program comprising computer program code which, when run on processing circuitry of a network node, causes the network node to perform a method according to the first aspect.

According to a fifth aspect there is presented a method for performing a UE-side beam selection procedure. The method is performed by a UE. The method comprises transmitting uplink signalling towards a TRP of a network node. The method comprises receiving, from the network node, reporting of TRP-side angular information of the UE from the uplink signalling and configuration for the UE to perform a UE-side beam selection procedure based on the TRP-side angular information. The method comprises selecting, as part of performing the UE-side beam selection procedure, a beam to use for communication with the TRP. The beam has a pointing direction that is selected as a function of the TRP-side angular information.

According to a sixth aspect there is presented a UE for performing a UE-side beam selection procedure. The UE comprises processing circuitry. The processing circuitry is configured to cause the UE to transmit uplink signalling towards a TRP of a network node. The processing circuitry is configured to cause the UE to receive, from the network node, reporting of TRP-side angular information of the UE from the uplink signalling and configuration for the UE to perform a UE-side beam selection procedure based on the TRP-side angular information. The processing circuitry is configured to cause the UE to select, as part of performing the UE-side beam selection procedure, a beam to use for communication with the TRP. The beam has a pointing direction that is selected as a function of the TRP-side angular information.

According to a seventh aspect there is presented a UE for performing a UE-side beam selection procedure. The UE comprises a transmit module configured to transmit uplink signalling towards a TRP of a network node. The UE comprises a receive module configured to receive, from the network node, reporting of TRP-side angular information of the UE from the uplink signalling and configuration for the UE to perform a UE-side beam selection procedure based on the TRP-side angular information. The UE comprises a select module configured to select, as part of performing the UE-side beam selection procedure, a beam to use for communication with the TRP. The beam has a pointing direction that is selected as a function of the TRP-side angular information.

According to an eighth aspect there is presented a computer program for performing a UE-side beam selection procedure, the computer program comprising computer program code which, when run on processing circuitry of a UE, causes the UE to perform a method according to the fifth aspect.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

According to a tenth aspect there is presented a system. The system comprises a network node according to any of the second or third aspects and a UE according to any of the sixth or seventh aspects.

Advantageously, these aspects enable the UE to perform a beam selection procedure based on angular information obtained at the TRP and reported from the TRP to the UE.

Advantageously, according to these aspects, the UE does not need to perform a beam sweeping procedure as in the legacy NR beam management P-3 sub-procedure to obtain beam quality information. In turn, this will save UE energy by avoiding multiple transmissions of reference signals in the downlink or multiple transmissions of reference signals in the uplink.

Advantageously, according to these aspects, the UE is enabled to select a refined, or narrower, beam at shorter delay due to the fact that no beam sweeping is needed.

Advantageously, according to these aspects, the UE does not need to perform any angle estimation procedure to obtain angular information for the purpose of beam refinement. In turn, this will save UE energy.

Advantageously, according to these aspects, the UE is enabled to update its beam separately in the azimuth domain or in the zenith domain or in both domains, depending on how fast the TRP-side angular information changes in each domain. In turn, this can save the use of the downlink feedback channel used by the network node to report the TRP-side angular information to the UE.

Advantageously, according to these aspects, the estimation of the angular information is performed by the network node which generally has a larger antenna array (and more available computational power) than the UE, enabling the estimation to be more accurate.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to examples;

FIG. 2 schematically illustrates a beam management procedure according to examples;

FIG. 3 is a schematic illustration of definition of spherical angles and spherical unit vectors in a Cartesian coordinate system according to embodiments;

FIGS. 4 and 5 are flowcharts of methods according to embodiments;

FIG. 6 is a schematic illustration of an example of angle correspondence between angle-of-arrival and angle-of-departure according to embodiments;

FIG. 7 is a signalling diagram of a method according to an embodiment;

FIG. 8 is a schematic diagram showing functional units of a network node according to an embodiment;

FIG. 9 is a schematic diagram showing functional modules of a network node according to an embodiment;

FIG. 10 is a schematic diagram showing functional units of a UE according to an embodiment;

FIG. 11 is a schematic diagram showing functional modules of a UE according to an embodiment;

FIG. 12 shows one example of a computer program product comprising computer readable means according to an embodiment;

FIG. 13 is a schematic diagram illustrating a telecommunication network connected via an intermediate network to a host computer in accordance with some embodiments; and

FIG. 14 is a schematic diagram illustrating host computer communicating via a radio base station with a terminal device over a partially wireless connection in accordance with some embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

As disclosed above, there is still a need for improved beam selection procedures. In this respect, the legacy NR beam management procedure disclosed above with reference to FIG. 2, after the initial BPL establishment (in the P-1 sub-procedure), the network node 200 and the UE 300 need to select a subset of narrow beams for the P-2 and P-3 sub-procedure. When the number of beams is very large, which is the case in higher frequency bands due to the use of very large antenna arrays, few beams should be selected to be swept in order to have a reasonable latency. However, knowing which beams to be used in the beam sweeping procedure becomes particularly challenging as the beams become narrower.

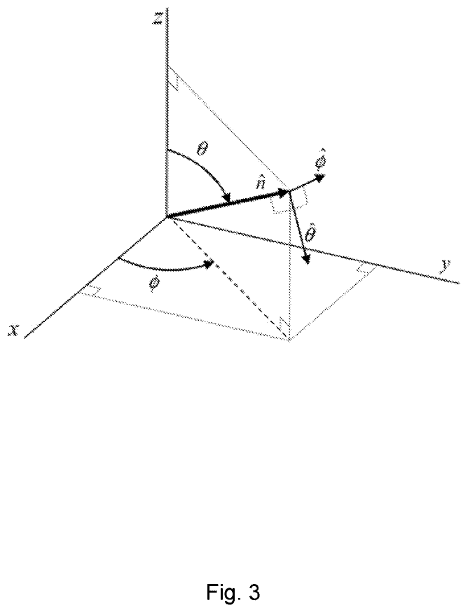

Angular information of the LOS path can suffice for the beams to be updated during the management procedures. This motivates the development of angular-based beam management procedures. In this respect, the channel state of the radio propagation channel between the TRP 140 and the UE 300 depends, among other things, on the relative geographical positions and orientations of the TRP 140 and the UE 300. In 3GPP TR 38. 901 “Study on channel model for frequencies from 0.5 to 100 GHz”, version 16.1.0, a common positioning system defined by coordinates in a Cartesian coordinate system, the spherical angles, and the spherical unit vector called a global coordinate system (GCS) is adopted, as shown in FIG. 3. In particular, FIG. 3 shows definition of spherical angles and spherical unit vectors in a Cartesian coordinate system, where n is the given direction, and where § and Ô are the spherical basis vectors.

An orientation-based beam management procedure might rely on the estimation of the angle-of-arrival (AoA) and/or angle-of-departure (AoD) for some signals transmitted between the TRP 140 and the UE 300. Given the angle estimate (in terms of angle-of-arrival or angle-of-departure), beams to be used both at the TRP 140 and the UE 300 can be refined, or updated, as in the P-2 or P-3 sub-procedures by at each side finding the most spatially aligned beam with the estimated angle.

However, the procedure for estimating the angle-of-arrival and the procedure for estimating the angle-of-departure require an independent procedure to be performed at each side; one is performed at the UE 300 for determining the UE-side beam and another is performed at the network node 200 for determining the TRP-side beam. That is, the UE-side beam refinement, or update, does not benefit from any angular information obtained by the network node 200.

The embodiments disclosed herein therefore relate to mechanisms for assisting a UE-side beam selection procedure and for performing a UE-side beam selection procedure. In order to obtain such mechanisms there is provided a network node 200, a method performed by the network node 200, a computer program product comprising code, for example in the form of a computer program, that when run on processing circuitry of the network node 200, causes the network node 200 to perform the method. In order to obtain such mechanisms there is further provided a UE 300, a method performed by the UE 300, and a computer program product comprising code, for example in the form of a computer program, that when run on processing circuitry of the UE 300, causes the UE 300 to perform the method.

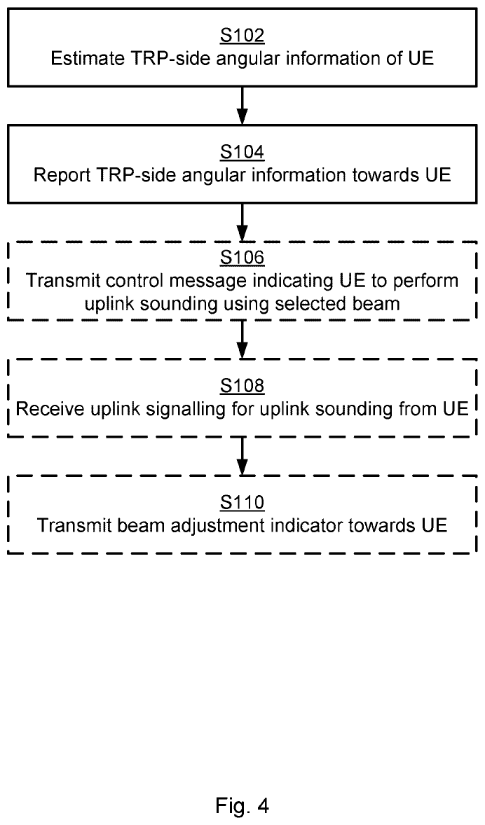

Reference is now made to FIG. 4 illustrating a method for assisting a UE-side beam selection procedure as performed by the network node 200 according to an embodiment.

S102: The network node 200 estimates TRP-side angular information of the UE 300 from uplink signalling received from the UE 300 at a TRP 140 of the network node 200. The TRP-side angular information is thus angular information of the UE 300 as estimated at the TRP-side.

S104: The network node 200 reports the TRP-side angular information towards the UE 300. Further, the network node 200 configures the UE 300 to perform a UE-side beam selection procedure based on the TRP-side angular information.

In that the network node 200 reports information towards the UE 300, the network node 200 thus feeds back, or otherwise provides, some useful information to the UE 300. According to the present disclosure, the useful information would be the TRP-side angular information, of which examples are provided below. This TRP-side angular information is reported to the UE 300 so that the UE 300 can use it to select a new beam (i.e., for the UE 300 to perform a UE-side beam selection procedure. In order for the UE 300 to know that it indeed should use the reported TRP-side angular information to select a new beam, the UE 300 needs to receive some indication from the network node 200 to do so. The network node 200 therefore configures the UE 300 to perform the UE-side beam selection procedure based on the TRP-side angular information, as in S104. Further in this respect, and as will be disclosed in more detail below with reference to FIG. 4, the UE 300 might therefore be configured by the network node 200 to (a) receive the report in some set of resources, e.g., of a shared channel, then (b) handle the reported information properly to eventually select a new beam, and then, optionally, (c) sound the selected beam in the uplink. In order to achieve this, items (a), (b), and (c) can realized as parameters, or fields, of the same control message or can be split into multiple control messages. Particularly, a control message related to item (a) may include the report itself instead of indicating what channel, resources, the report will be sent in. In other words, the content of the report (i.e., TRP-side angular information) could be part of a control message, such as the control message for item (a).

Embodiments relating to further details of assisting a UE-side beam selection procedure as performed by the network node 200 will now be disclosed.

There could be different examples of TRP-side angular information of the UE 300 that is estimated by the network node 200 in S102. In some embodiments the TRP-side angular information is an estimate of angle-of-arrival at the TRP 140 of the uplink signalling received from the UE 300. The network node 200 might estimate the angle-of-arrival either in the azimuth domain or in the elevation domain, or in both domains, depending on the channel dynamics and/or mobility pattern of the UE 300. Particularly, in some embodiments the angle-of-arrival pertains to angle-of-arrival in azimuth, or in elevation, or both azimuth and elevation. In some examples, the network node 200 configures the UE 300 with a different beam selection periodicity in each angle domain. In some cases, it is of interest to refine the beam selection at the UE 300 in both angle domains, and thus that the TRP-side angular information is defined in both azimuth and elevation domain. In other cases, the angular characteristics of the radio propagation channel varies faster in one angle domain than in the other angle domain, and thus the TRP-side angular information with the angle domain that varies faster should be reported more frequently.

There could be different ways in which the network node 200 estimates the TRP-side angular information of the UE 300 from the uplink signalling received from the UE 300. In some aspects, the network node 200 estimates the TRP-side angular information that characterizes the radio propagation channel between the UE 300 and the TRP 140 through a set of reference signals transmitted by the UE 300 in the uplink. Particularly, in some embodiments the TRP-side angular information of the UE 300 is estimated from uplink signalling in terms of a set of reference signals. The reference signals might be sounding reference signals (SRS), as defined by 3GPP. Any combination of uplink reference signal transmission and angle estimation technique can be adopted for the purpose of obtaining the TRP-side angular information. Any other combination also considering downlink reference signal transmissions can also be adopted for the same purpose.

In some aspects, the network node 200 configures the UE 300 to update its beam in azimuth domain or in elevation domain, either separately or jointly in both domains. As an example, the network node 200 might transmit a downlink control message to the UE 300 to configure the UE 300 to perform the UE-side beam selection procedure. Particularly, in some embodiments the UE 300 is by the network node 200 configured to perform the UE-side beam selection procedure only in azimuth domain, only in elevation domain, or in both azimuth and elevation domains. The control message might further indicate downlink resources in which the UE 300 will receive the TRP-side angular information. The control message might further indicate to the UE 300 the type of TRP-side angular information that will be reported; an azimuth angle, an elevation angle, or both an azimuth angle and an elevation angle. The control message might further indicate to the UE 300 what coordinate system the TRP-side angular information is defined in. In some cases, there might be a list of coordinate systems in which the TRP-side angular information can be defined. In some other cases, there is a single reference coordinate system already known by both the network node 200 and the UE 300, which dismiss the need for any coordinate system indication.

In some aspects, the network node 200 transmits a control message that indicates that uplink sounding with the beam as selected by the UE 300 is needed. Particularly, in some embodiments, the network node 200 is configured to perform (optional) step S106:

S106: The network node 200 transmits a control message towards the UE 300. The control message indicates that the UE 300 is to perform uplink sounding using a beam selected by the UE 300 as part of performing UE-side beam selection procedure.

Hence, a control message might be transmitted by the network node 200 that indicates to the UE 300 whether an uplink sounding with the beam as selected by the UE 300 is needed. If such an uplink sounding is indicated as needed, the control message might also indicate configured uplink resources for the UE 300 to use for transmission of an uplink sounding signal with the beam as selected by the UE 300.

As will be disclosed below, the UE 300 might then use the selected beam when transmitting an uplink signalling for uplink sounding. Hence, in some aspects, the network node 200 receives a beamformed sounding signal from the UE 300 in a configured set of uplink resources. Therefore, the UE 300 might by the network node 200 be configured to transmit uplink signalling for uplink sounding in this configured set of uplink resources. In some embodiments, the network node 200 is therefore configured to perform (optional) step S108:

S108: The network node 200 receives uplink signalling for uplink sounding from the UE 300 using the beam selected by the UE 300.

In some examples, the network node 200 evaluates the uplink signalling by measuring the corresponding beam quality in terms of layer 1 reference signal received power (L1-RSRP). Other Li measurements, or even higher layer measurements, can be adopted for the same purpose.

After having evaluated the quality of the beam selected by the UE 300, the network node 200 might transmit a beam adjustment indication for the UE 300 to either use the new beam or to keep a previous or current beam. In some aspects, the new beam should be used if it provides a BPL with better quality compared to the BPL with the previous or current beam. In some aspects, upon reception and evaluation of the uplink signalling, the network node 200 might thus determine and transmit to the UE 300 a beam adjustment indicator based on the previously measured beamformed sounding signal. In some embodiments, the network node 200 is therefore configured to perform (optional) step S110:

S110: The network node 200 transmits a beam adjustment indicator towards the UE 300.

In some embodiments, the beam adjustment indicator is transmitted only when received power of the uplink signalling is more than a threshold value lower than received power of previously received uplink signalling from the UE 300. However, in other embodiments, the beam adjustment indicator is always transmitted to inform the UE 300 whether or not to keep the selected beam in which the UE transmitted the uplink signal.

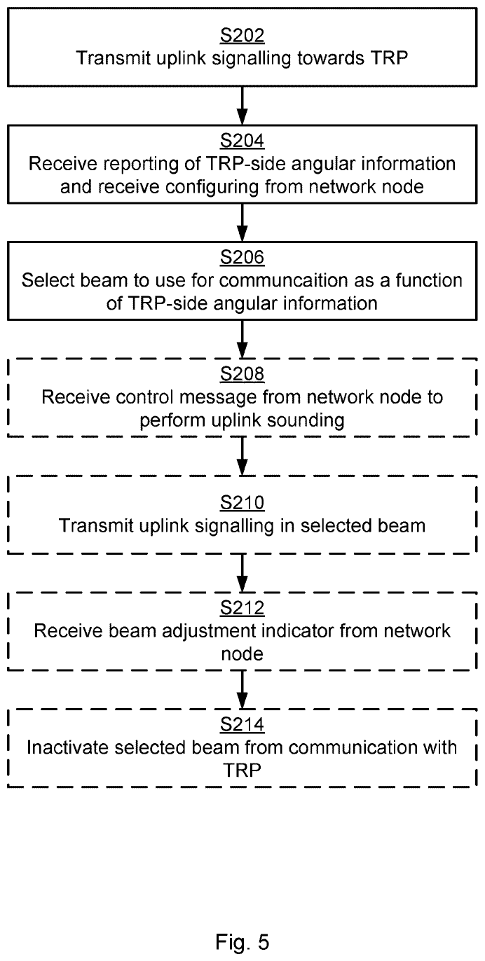

Reference is now made to FIG. 5 illustrating a method for performing a UE-side beam selection procedure as performed by the UE 300 according to an embodiment.

S202: The UE transmits uplink signalling towards the TRP 140 of the network node 200. In some embodiments, the uplink signalling is transmitted in terms of a set of reference signals. Different reference signals can be adopted for the same purpose.

S204: The UE 300 receives, from the network node 200, reporting of TRP-side angular information of the UE 300 from the uplink signalling. The UE 300 further receives configuration for the UE 300 to perform a UE-side beam selection procedure based on the TRP-side angular information.

S206: The UE 300 selects, as part of performing the UE-side beam selection procedure, a beam to use for communication with the TRP 140. The beam has a pointing direction that is selected as a function of the TRP-side angular information.

This procedure can be carried out for the UE 300 to find a narrower beam within the angular space covered by a given wider beam that is currently used by the UE 300. Assume that the UE 300 is using a wide beam covering the angular interval [0, 20] (in degree) in azimuth, for instance. Then, a refined, or narrower beam, could be selected within this interval, say covering [5,10] in azimuth, for instance. Such a refined, or narrower beam, could have a larger beam gain within the narrower angular interval than the wide beam. Hence, with reference to FIG. 2, this procedure could be used by the UE 300 in the P-3 sub-procedure. In fact, this procedure could replace the actions taken by the UE 300 in the P-3 sub-procedure.

Embodiments relating to further details of performing a UE-side beam selection procedure as performed by the UE 300 will now be disclosed.

As further disclosed above, the network node 200 might estimate the angle-of-arrival either in the azimuth domain or in the elevation domain, or in both domains, depending on the channel dynamics and/or mobility pattern of the UE 300. Particularly, in some embodiments the angle-of-arrival pertains to angle-of-arrival in azimuth, or in elevation, or both azimuth and elevation.

In some aspects, the UE 300 transforms the received TRP-side angular information to its own coordinate system, considering the coordinate system in which the TRP-side angular information is defined. Particularly, in some embodiments the TRP-side angular information is defined in a first coordinate system, the beam is selected in a second coordinate system, and the UE 300 as part of selecting the beam transforms the TRP-side angular information to the second coordinate system. There could be different examples of the first coordinate system and the second coordinate system. Particularly, in some embodiments the TRP 140 is oriented with respect to the first coordinate system and the UE 300 is oriented with respect to the second coordinate system. The first coordinate system might be a global coordinate system (GCS), and the second coordinate system might be a local coordinate system (LCS). In further detail, an antenna array at the UE 300 can be oriented with respect the LCS that has the center of the antenna array as the origin of LCS, which is used as a reference to define the far-field. The reference directions in the LCS will depend on the orientation of the antenna array, which varies with the orientation of the UE 300. Angular information regarding rays/paths, i.e., angle-of-arrival and angle-of-departure, can be characterized in terms of either the GCS or LCS. The LCS can be determined by a sequence of rotation angles (a, B and y) regarding axes (x, y and z) over the GCS. The TRP-side angular information might thus be transformed from the first coordinate system to the second coordinate system according to a relation between the first coordinate system and the second coordinate system, and wherein the relation is determined by the UE 300.

As disclosed above, a control message as transmitted by the network node 200 might indicate to the UE 300 what coordinate system the TRP-side angular information is defined in. Particularly, in some embodiments the relation is determined from information defining the first coordinate system as received in a control message from the network node 200.

In some aspects, the relation between the first coordinate system and the second coordinate system can be determined based on rotational information. Particularly, in some embodiments the relation is determined from a rotation of the UE 300, with respect to the first coordinate system, as locally obtained by the UE 300.

The LCS rotation angles can be used to characterize the UE and/or TRP rotation matrices, as in Equation (1):

$$R = ( \begin{matrix}cos α & - sin α & 0 \\ sin α & cos α & 0 \\ 0 & 0 & 1\end{matrix} ) ( \begin{matrix}cos β & 0 & sin β \\ 0 & 1 & 0 \\ - sin β & 0 & cos β\end{matrix} ) ( \begin{matrix}1 & 0 & 0 \\ 0 & cos γ & - s in γ \\ 0 & sin γ & cos γ\end{matrix} ) . \qquad ( 1 )$$

The transformation R can be used to convert coordinates from the LCS to the GCS. The reverse transformation R⁻¹, i.e., to convert coordinates from the GCS to the LCS, and thus to transform the TRP-side angular information to UE-side angular information, is equal to the transpose of R. That is, R⁻¹=R^{T}.

Rotational information thus can be used by the UE 300 to transform the received TRP-side angular information to its LCS. Such rotational information can be obtained for example from an inertial measurement unit (IMU) that can be an accelerometer, gyroscopes, or magnetometers.

Assume further that the network node 200 also has its own LCS (which is different from both the GCS and the LCS of the UE 300) and that the network node 200 first estimates the TRP-side angular information in its own LCS. In case of a single LOS path scenario, let (ϕ_{LOS}′, θ_{LOS}′) be angles-of-arrival obtained by the network node 200 in its own LCS. The network node 200 can then transform the TRP-side angular information from its own LCS to a reference GCS in two steps. First, both angles (ϕ_{LOS}′, θ_{LOS}′) are transformed to the GCS using the matrix R in Equation (2), as follows:

$$r = {R}_{t} [ \begin{matrix}cos ( {ϕ}_{LOS , TRP}^{′} ) sin ( {θ}_{LOS , TRP}^{′} ) \\ sin ( {ϕ}_{LOS , TRP}^{′} ) sin ( {θ}_{LOS , TRP}^{′} ) \\ cos ( {θ}_{LOS , TRP}^{′} )\end{matrix} ] . \qquad ( 2 )$$

Second, the angles in the GCS (ϕ_{LOS}, θ_{LOS}) are obtained from Equation (2) according to Equations (3) and (4):

$${ϕ}_{LOS , trp} = arg \{ ( [ \begin{matrix}1 & 0 & 0\end{matrix} ] + j [ \begin{matrix}0 & 1 & 0\end{matrix} ] ) r \} , \qquad ( 3 )$$

$$and$$

$${θ}_{LOS , trp} = arccos ( [ \begin{matrix}0 & 0 & 1\end{matrix} ] r ) . \qquad ( 4 )$$

The TRP-side angular information (ϕ_{LOS,trp}, θ_{LOS,trp}) can be used by the UE 300 to obtain UE-side angular information (ϕ_{LOS,UE}, θ_{LOS,UE}) in the GCS according to Equations (5) and (6):

$${ϕ}_{LOS , UE} = \{ \begin{matrix}{ϕ}_{LOS , trp} + π , & if ϕ < 0 , \\ {ϕ}_{LOS , trp} - π , & if ϕ \geq 0 ,\end{matrix} \qquad ( 5 )$$

$$and$$

$${θ}_{LOS , UE} = π - {θ}_{LOS , TRP} . \qquad ( 6 )$$

Finally, the UE 300 transforms the pair of angles in Equations (5) and (6) into its own LCS using Equations (7), (8), and (9):

$${r}^{′} = {R}_{UE}^{- 1} [ \begin{matrix}cos ( {ϕ}_{LOS , UE} ) sin ( {θ}_{LOS , UE} ) \\ sin ( {ϕ}_{LOS , UE} ) sin ( {θ}_{LOS , UE} ) \\ cos ( {θ}_{LOS , UE} )\end{matrix} ] , \qquad ( 7 )$$

$${ϕ}_{LOS , UE}^{′} = arg \{ ( [ \begin{matrix}1 & 0 & 0\end{matrix} ] + j [ \begin{matrix}0 & 1 & 0\end{matrix} ] ) {r}^{′} \} , \qquad ( 8 )$$

$${θ}_{LOS , UE}^{′} = arccos ( [ \begin{matrix}0 & 0 & 1\end{matrix} ] {r}^{′} ) . \qquad ( 9 )$$

The UE 300 thus selects a new UE-side beam, as in S206, based on the received TRP-side angular information transformed into its LCS.

In some aspects, the UE 300 selects the beam being most spatially aligned with the angle-of-arrival. Particularly, in some embodiments the beam is selected to, according to a given metric, have an angle-of-departure that is spatially aligned with the angle-of-arrival.

In general terms, the beam selected by the UE 300 in S206 can be represented by a vector of complex-valued weights that shift the phase and/or amplitude of signals in each antenna element of the antenna array at the UE 300. This weight vector (or simply beam vector) can be designed in order to radiate energy towards an intended spatial direction (e.g., pair of azimuth and zenith angles). A steering vector function can be used to map a pair of azimuth and zenith angles to a beam vector. The steering vector function also depends on the wavelength and antenna element positions. However, in some cases, a beam pointing to an intended direction cannot be realized in practice due to hardware limitations. In this context, a grid of beams, i.e., a set of feasible beam vectors, could be adopted. Then, one out of such beam vectors should be selected. The selection criterion, or metric as referred to above, might be based on some spatial alignment criterion, such as cross-correlation between the beam pointing to an intended direction and the feasible beam vectors. According to the metric, the feasible beam vector that yields the highest cross-correlation is be selected. For a grid-of-beam, the selection can be simplified by using known per beam angle information. For example, the beam with closest bore sight pointing direction, e.g. smallest angle difference compared to a desired direction (as given by the TRP-angular information), can be selected. Or the Half Power Beam Width (HPBW; defined as the reduction by 3 dB from the peak gain) angle range, for example the beam with angle range with largest angle coverage beyond the desired direction, can be selected.

As disclosed above, there could be different examples of TRP-side angular information of the UE 300. Particularly, in some embodiments the TRP-side angular information is an estimate of angle-of-arrival at the TRP 140 of the uplink signalling transmitted by the UE 300. In some aspects, the UE 300 is configured by the network node 200 to update its beam in azimuth domain or in elevation domain, either separately or jointly in both domains. Particularly, in some embodiments the UE 300 is configured to perform the UE-side beam selection procedure only in azimuth domain, only in elevation domain, or in both azimuth and elevation domains. In some examples, the spatial characteristics of the beam as selected in S206 differ from a previous or current UE-side beam in both azimuth and elevation domains if the received TRP-side angular information comprises both domains. In other examples, the spatial characteristics of the beam as selected in S206 differ from the previous or current UE-side beam only in the azimuth domain, whilst the characteristics in the elevation domain are kept as in the previous or current UE-side beam. In yet other examples, the spatial characteristics of the beam as selected in S206 differ from the previous or current UE-side beam only in the elevation domain, whilst the characteristics in the azimuth domain are kept as in the previous or current UE-side beam.

As disclosed above, the network node 200 might transmit a control message that indicates that uplink sounding with the beam as selected by the UE 300 is needed. In some embodiments, the UE 300 is therefore configured to perform (optional) step S208:

S208: The UE 300 receives a control message from the network node 200. The control message indicates that the UE 300 is to perform uplink sounding using the beam selected by the UE 300.

The UE 300 might then transmit uplink signalling in accordance with the control message received from the network node 200 in S208. Therefore, in some embodiments, the UE 300 is configured to perform (optional) step S210:

S210: The UE 300 transmits uplink signalling for uplink sounding in the beam selected by the UE 300.

The uplink signalling might comprise uplink reference signals, such as one or more sounding reference signals. Different reference signals can be adopted for the same purpose.

As disclosed above, the network node 200 might transmit a beam adjustment indication for the UE 300 to either use the new beam or to keep a previous or current beam. Therefore, in some embodiments, the UE 300 is configured to perform (optional) steps S212 and S214:

S212: The UE 300 receives a beam adjustment indicator from the network node 200.

S214: The UE 300 inactivates the beam selected by the UE 300 from communication with the TRP 140 when the beam adjustment indicator indicates that received power of the uplink signalling is more than a threshold value lower than received power of previously received uplink signalling from the UE 300.

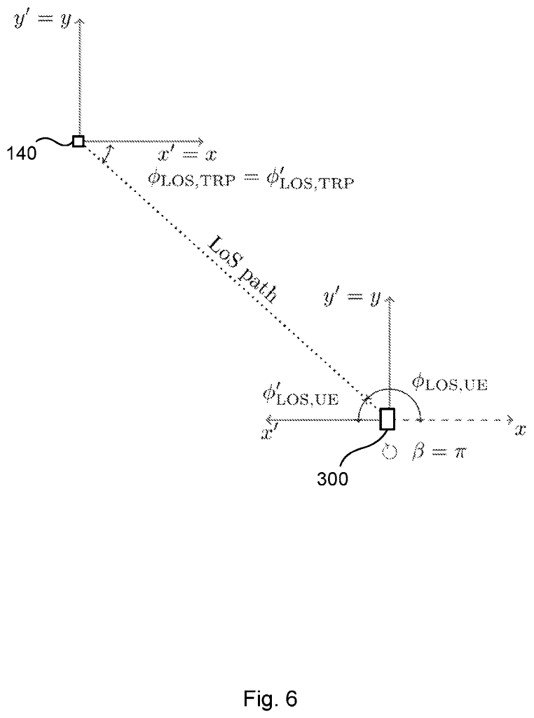

FIG. 6 schematically illustrates an example of angle correspondence between angle-of-arrival (at the TRP 140) and angle-of-departure (at the UE 300) of a LOS propagation path between the TRP 140 and the UE 300. For simplicity of illustration but without loss of generality, both the angle-of-arrival and the angle-of-departure are in the azimuth domain (i.e., the XY plane). The x-axis and the y-axis are in a common GCS, whilst the x′-axis and the y′-axis are in the LCS of the UE 300. For simplicity, the TRP's LCS is aligned with the GCS. The UE 300 is rotated around the y-axis by β=π. The UE's 300 rotation around the y-axis thus shifts its x′-axis to the opposite direction of the x-axis. The angle-of-arrival ϕ_{LOS,UE}′ in the LCS of the UE 300 can be determined from the angle-of-arrival ϕ_{LOS,TRP} in the GCS as long as the rotation angle β is known, or can be determined or at least estimated by the UE 300 and/or the network node 200.

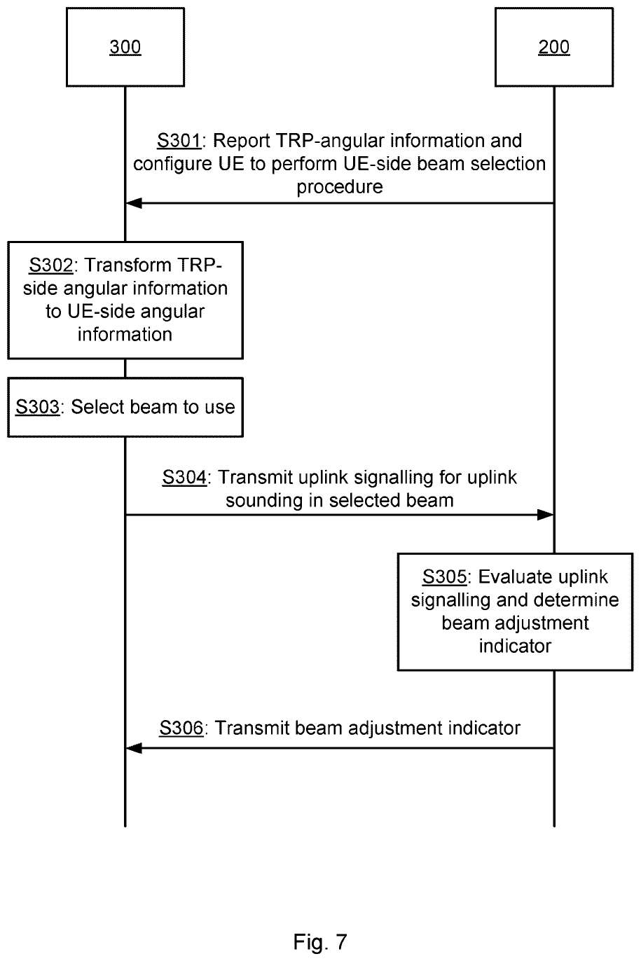

One particular embodiment for assisting a UE-side beam selection procedure as performed by the network node 200 and for performing a UE-side beam selection procedure as performed by the UE 300 based on at least some of the above disclosed embodiments will now be disclosed in detail with reference to the signalling diagram of FIG. 7.

S301: The network node 200 reports TRP-side angular information towards the UE 300 and configures the UE 300 to perform a UE-side beam selection procedure based on the TRP-side angular information.

S302: The UE 300 transforms the TRP-side angular information to its own LCS.

S303: The UE 300 selects, as part of performing the UE-side beam selection procedure, a beam to use for communication with the TRP 140 of the network node 200. The beam has a pointing direction that is selected as a function of the TRP-side angular information (in the LCS of the UE 300).

S304: The UE 300 transmitting, in the beam selected by the UE 300, uplink signalling for uplink sounding.

S305: The network node 200 evaluates the uplink signalling and determines a beam adjustment indicator.

S306: The network node 200 transmits the beam adjustment indicator towards the UE 300.

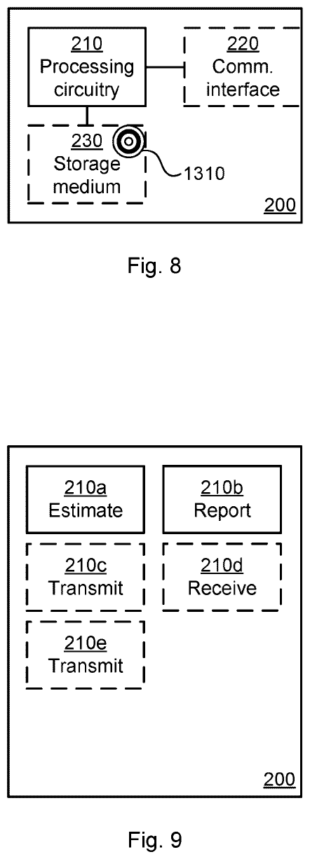

FIG. 8 schematically illustrates, in terms of a number of functional units, the components of a network node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1210a (as in FIG. 12), e.g. in the form of a storage medium 230. The processing circuitry 210 may further be provided as at least one application specific integrated circuit (ASIC), or field programmable gate array (FPGA).

Particularly, the processing circuitry 210 is configured to cause the network node 200 to perform a set of operations, or steps, as disclosed above. For example, the storage medium 230 may store the set of operations, and the processing circuitry 210 may be configured to retrieve the set of operations from the storage medium 230 to cause the network node 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

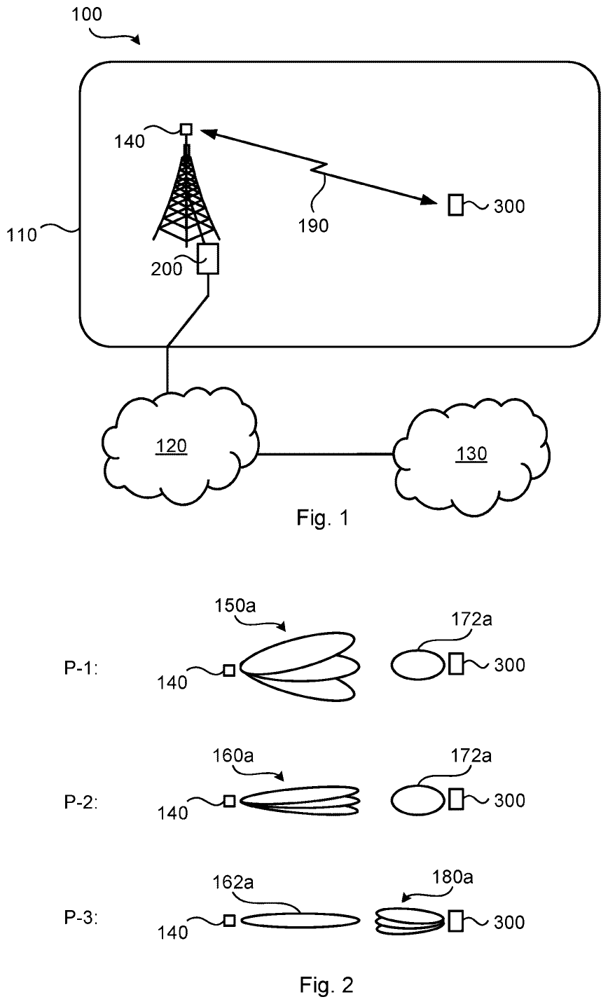

The network node 200 may further comprise a communications interface 220 for communications with other entities, functions, nodes, and devices, as in FIG. 1. As such the communications interface 220 may comprise one or more transmitters and receivers, comprising analogue and digital components.

The processing circuitry 210 controls the general operation of the network node 200 e.g. by sending data and control signals to the communications interface 220 and the storage medium 230, by receiving data and reports from the communications interface 220, and by retrieving data and instructions from the storage medium 230. Other components, as well as the related functionality, of the network node 200 are omitted in order not to obscure the concepts presented herein.

FIG. 9 schematically illustrates, in terms of a number of functional modules, the components of a network node 200 according to an embodiment. The network node 200 of FIG. 9 comprises a number of functional modules; an estimate module 210a configured to perform step S102, and a report module 210b configured to perform step S104. The network node 200 of FIG. 9 may further comprise a number of optional functional modules, such as any of a transmit module 210c configured to perform step S106, a receive module 210d configured to perform step S108, and a transmit module 210e configured to perform step S110. In general terms, each functional module 210a: 210e may be implemented in hardware or in software. Preferably, one or more or all functional modules 210a: 210e may be implemented by the processing circuitry 210, possibly in cooperation with the communications interface 220 and/or the storage medium 230. The processing circuitry 210 may thus be arranged to from the storage medium 230 fetch instructions as provided by a functional module 210a: 210e and to execute these instructions, thereby performing any steps of the network node 200 as disclosed herein.

The network node 200 may be provided as a standalone device or as a part of at least one further device. For example, the network node 200 may be provided in a node of the radio access network (such as the TRP 140) or in a node of the core network. Alternatively, functionality of the network node 200 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time.

Thus, a first portion of the instructions performed by the network node 200 may be executed in a first device, and a second portion of the instructions performed by the network node 200 may be executed in a second device; the herein disclosed embodiments are not limited to any particular number of devices on which the instructions performed by the network node 200 may be executed. Hence, the methods according to the herein disclosed embodiments are suitable to be performed by a network node 200 residing in a cloud computational environment. Therefore, although a single processing circuitry 210 is illustrated in FIG. 8 the processing circuitry 210 may be distributed among a plurality of devices, or nodes. The same applies to the functional modules 210a: 210e of FIG. 9 and the computer program 1220a of FIG. 12.

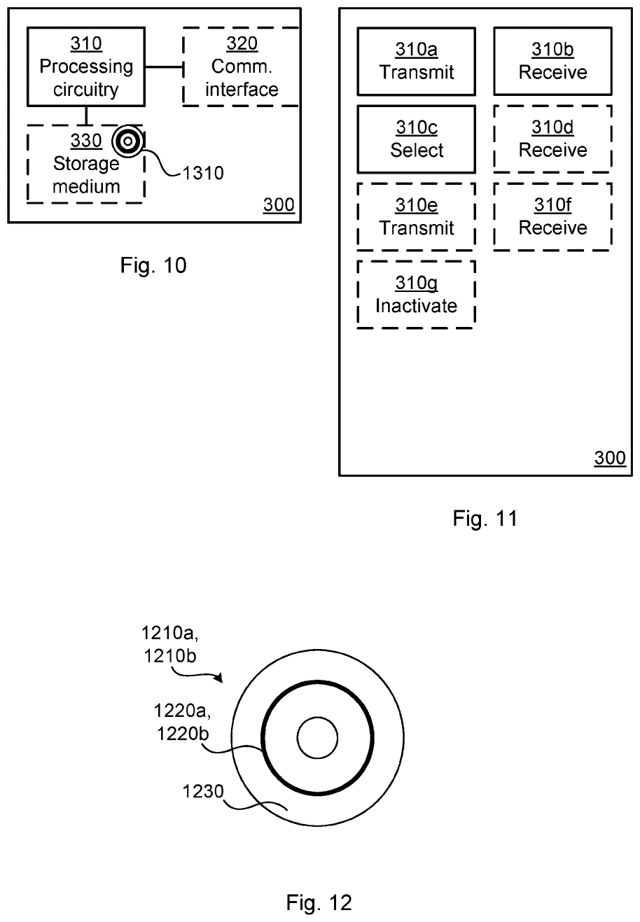

FIG. 10 schematically illustrates, in terms of a number of functional units, the components of a UE 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1210b (as in FIG. 12), e.g. in the form of a storage medium 330. The processing circuitry 310 may further be provided as at least one application specific integrated circuit (ASIC), or field programmable gate array (FPGA).

Particularly, the processing circuitry 310 is configured to cause the UE 300 to perform a set of operations, or steps, as disclosed above. For example, the storage medium 330 may store the set of operations, and the processing circuitry 310 may be configured to retrieve the set of operations from the storage medium 330 to cause the UE 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The UE 300 may further comprise a communications interface 320 for communications with other entities, functions, nodes, and devices, as in FIG. 1. As such the communications interface 320 may comprise one or more transmitters and receivers, comprising analogue and digital components.

The processing circuitry 310 controls the general operation of the UE 300 e.g. by sending data and control signals to the communications interface 320 and the storage medium 330, by receiving data and reports from the communications interface 320, and by retrieving data and instructions from the storage medium 330. Other components, as well as the related functionality, of the UE 300 are omitted in order not to obscure the concepts presented herein.

FIG. 11 schematically illustrates, in terms of a number of functional modules, the components of a UE 300 according to an embodiment. The UE 300 of FIG. 11 comprises a number of functional modules; a transmit module 310a configured to perform step S202, a receive module 310b configured to perform step S204, and a select module 310c configured to perform step S206. The UE 300 of FIG. 11 may further comprise a number of optional functional modules, such as any of a receive module 310d configured to perform step S208, a transmit module 310e configured to perform step S210, a receive module 310f configured to perform step S212, an inactivate module 310g configured to perform step S214. In general terms, each functional module 310a: 310g may be implemented in hardware or in software. Preferably, one or more or all functional modules 310a: 310g may be implemented by the processing circuitry 310, possibly in cooperation with the communications interface 320 and/or the storage medium 330. The processing circuitry 310 may thus be arranged to from the storage medium 330 fetch instructions as provided by a functional module 310a: 310g and to execute these instructions, thereby performing any steps of the UE 300 as disclosed herein.

FIG. 12 shows one example of a computer program product 1210a, 1210b comprising computer readable means 1230. On this computer readable means 1230, a computer program 1220a can be stored, which computer program 1220a can cause the processing circuitry 210 and thereto operatively coupled entities and devices, such as the communications interface 220 and the storage medium 230, to execute methods according to embodiments described herein. The computer program 1220a and/or computer program product 1210a may thus provide means for performing any steps of the network node 200 as herein disclosed. On this computer readable means 1230, a computer program 1220b can be stored, which computer program 1220b can cause the processing circuitry 310 and thereto operatively coupled entities and devices, such as the communications interface 320 and the storage medium 330, to execute methods according to embodiments described herein. The computer program 1220b and/or computer program product 1210b may thus provide means for performing any steps of the UE 300 as herein disclosed.

In the example of FIG. 12, the computer program product 1210a, 1210b is illustrated as an optical disc, such as a CD (compact disc) or a DVD (digital versatile disc) or a Blu-Ray disc. The computer program product 1210a, 1210b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1220a, 1220b is here schematically shown as a track on the depicted optical disk, the computer program 1220a, 1220b can be stored in any way which is suitable for the computer program product 1210a, 1210b.

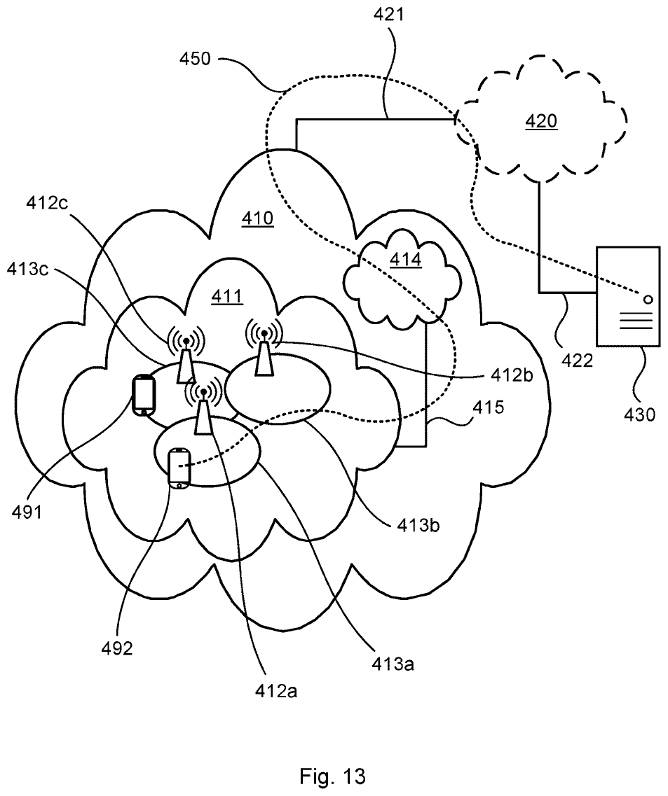

FIG. 13 is a schematic diagram illustrating a telecommunication network connected via an intermediate network 420 to a host computer 430 in accordance with some embodiments. In accordance with an embodiment, a communication system includes telecommunication network 410, such as a 3GPP-type cellular network, which comprises access network 411, such as radio access network 110 in FIG. 1, and core network 414, such as core network 120 in FIG. 1. Access network 411 comprises a plurality of radio access network nodes 412a, 412b, 412c, such as NBs, eNBs, gNBs (each corresponding to the network node 200 of FIG. 1) or other types of wireless access points, each defining a corresponding coverage area, or cell, 413a, 413b, 413c. Each radio access network nodes 412a, 412b, 412c is connectable to core network 414 over a wired or wireless connection 415. A first UE 491 located in coverage area 413c is configured to wirelessly connect to, or be paged by, the corresponding network node 412c. A second UE 492 in coverage area 413a is wirelessly connectable to the corresponding network node 412a. While a plurality of UE 491, 492 are illustrated in this example, the disclosed embodiments are equally applicable to a situation where a sole UE is in the coverage area or where a sole terminal device is connecting to the corresponding network node 412. The UEs 491, 492 correspond to the UE 300 of FIG. 1.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 13 as a whole enables connectivity between the connected UEs 491, 492 and host computer 430. The connectivity may be described as an over-the-top (OTT) connection 450. Host computer 430 and the connected UEs 491, 492 are configured to communicate data and/or signalling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, network node 412 may not or need not be informed about the past routing of an incoming downlink communication with data originating from host computer 430 to be forwarded (e.g., handed over) to a connected UE 491. Similarly, network node 412 need not be aware of the future routing of an outgoing uplink communication originating from the UE 491 towards the host computer 430.

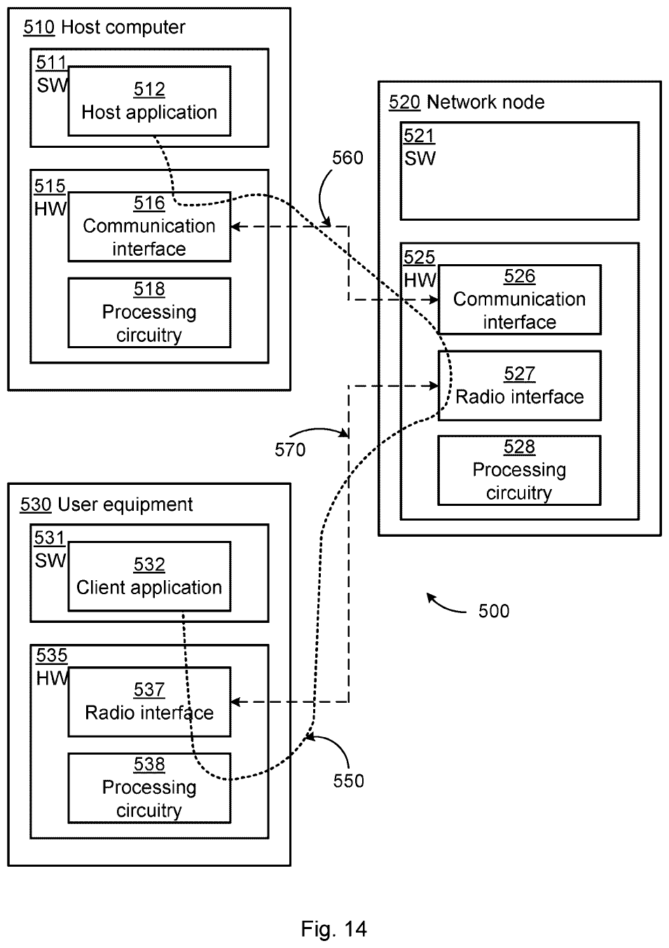

FIG. 14 is a schematic diagram illustrating host computer communicating via a radio access network node with a UE over a partially wireless connection in accordance with some embodiments. Example implementations, in accordance with an embodiment, of the UE, radio access network node and host computer discussed in the preceding paragraphs will now be described with reference to FIG. 14. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. The UE 530 corresponds to the UE 300 of FIG. 1. In providing the service to the remote user, host application 512 may provide user data which is transmitted using OTT connection 550.

Communication system 500 further includes radio access network node 520 provided in a telecommunication system and comprising hardware 525 enabling it to communicate with host computer 510 and with UE 530. The radio access network node 520 corresponds to the network node 200 of FIG. 1. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 14) served by radio access network node 520. Communication interface 526 may be configured to facilitate connection 560 to host computer 510. Connection 560 may be direct or it may pass through a core network (not shown in FIG. 14) of the telecommunication system and/or through one or more intermediate networks outside the telecommunication system. In the embodiment shown, hardware 525 of radio access network node 520 further includes processing circuitry 528, which may comprise one or more programmable processors, application-specific integrated circuits, field programmable gate arrays or combinations of these (not shown) adapted to execute instructions. Radio access network node 520 further has software 521 stored internally or accessible via an external connection.

Communication system 500 further includes UE 530 already referred to. Its hardware 535 may include radio interface 537 configured to set up and maintain wireless connection 570 with a radio access network node serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, radio access network node 520 and UE 530 illustrated in FIG. 14 may be similar or identical to host computer 430, one of network nodes 412a, 412b, 412c and one of UEs 491, 492 of FIG. 13, respectively. This is to say, the inner workings of these entities may be as shown in FIG. 14 and independently, the surrounding network topology may be that of FIG. 13.

In FIG. 14, OTT connection 550 has been drawn abstractly to illustrate the communication between host computer 510 and UE 530 via network node 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and radio access network node 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may reduce interference, due to improved classification ability of airborne UEs which can generate significant interference.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect network node 520, and it may be unknown or imperceptible to radio access network node 520. Such procedures and functionalities may be known and practiced in the art. In certain embodiments, measurements may involve proprietary UE signalling facilitating host computer's 510 measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1-8. (canceled)

9. A method for performing a user equipment (UE)-side beam selection procedure, the method being performed by a UE (300), the method comprising:
transmitting (S202) uplink signalling towards a transmission and reception point (TRP) (140) of a network node (200);
receiving (S204), from the network node (200), reporting of TRP-side angular information of the UE (300) from the uplink signalling and configuration for the UE (300) to perform a UE-side beam selection procedure based on the TRP-side angular information; and
selecting (S206), as part of performing the UE-side beam selection procedure, a beam to use for communication with the TRP (140), wherein the beam has a pointing direction that is selected as a function of the TRP-side angular information.

10. The method according to claim 9, wherein the TRP-side angular information is defined in a first coordinate system, wherein the beam is selected in a second coordinate system, and wherein the UE (300) as part of selecting the beam transforms the TRP-side angular information to the second coordinate system.

11. The method according to claim 10, the TRP (140) is oriented with respect to the first coordinate system and the UE (300) is oriented with respect to the second coordinate system.

12. The method according to claim 10, wherein the TRP-side angular information is transformed from the first coordinate system to the second coordinate system according to a relation between the first coordinate system and the second coordinate system, and wherein the relation is determined by the UE (300).

13. The method according to claim 12, wherein the relation is determined from information defining the first coordinate system as received in a control message from the network node (200).

14. The method according to claim 12, wherein the relation is determined from a rotation of the UE (300), with respect to the first coordinate system, as locally obtained by the UE (300).

15. The method according to claim 9, wherein the TRP-side angular information is an estimate of angle-of-arrival at the TRP (140) of the uplink signalling transmitted by the UE (300).

16. The method according to claim 15, wherein the angle-of-arrival pertains to angle-of-arrival in azimuth, or in elevation, or both azimuth and elevation.

17. The method according to claim 9, wherein the beam is selected to, according to a given metric, have an angle-of-departure that is spatially aligned with the angle-of-arrival.

18. The method according to claim 9, wherein the UE (300) is configured to perform a UE-side beam selection procedure only in azimuth domain, only in elevation domain, or in both azimuth and elevation domains.

19. The method according to claim 9, wherein the uplink signalling is transmitted in terms of a set of reference signals.

20. The method according to claim 9, wherein the method further comprises:
receiving (S208) a control message from the network node (200), the control message indicating that the UE (300) is to perform uplink sounding using the beam selected by the UE (300).

21. The method according to claim 9, wherein the method further comprises:
transmitting (S210) uplink signalling for uplink sounding in the beam selected by the UE (300).

22. The method according to claim 9, wherein the method further comprises:
receiving (S212) a beam adjustment indicator from the network node (200); and
inactivating (S214) the beam selected by the UE (300) from communication with the TRP (140) when the beam adjustment indicator indicates that received power of the uplink signalling is more than a threshold value lower than received power of previously received uplink signalling from the UE (300).

23. A network node (200) for assisting a user equipment (UE)-side beam selection procedure, the network node (200) comprising processing circuitry (210), the processing circuitry being configured to cause the network node (200) to:
estimate TRP-side angular information of a UE (300) from uplink signalling received from the UE (300) at a transmission and reception point (TRP) (140) of the network node (200); and
report the TRP-side angular information towards the UE (300) and configure the UE (300) to perform a UE-side beam selection procedure based on the TRP-side angular information.

24. (canceled)

25. The network node (200) according to claim 23, further being configured to perform the method of:
estimating (S102) TRP-side angular information of a UE (300) from uplink signalling received from the UE (300) at a TRP (140) of the network node (200); and
reporting (S104) the TRP-side angular information towards the UE (300) and configuring the UE (300) to perform a UE-side beam selection procedure based on the TRP-side angular information.

26-29. (canceled)

30. A computer program (1220a) for assisting a user equipment (UE)-side beam selection procedure, the computer program comprising computer code which, when run on processing circuitry (210) of a network node (200), causes the network node (200) to:
estimate (S102) transmission and reception point (TRP)-side angular information of a UE (300) from uplink signalling received from the UE (300) at a TRP (140) of the network node (200); and
report (S104) the TRP-side angular information towards the UE (300) and configuring the UE (300) to perform a UE-side beam selection procedure based on the TRP-side angular information.

31. (canceled)

32. A computer program product (1210a, 1210b) comprising a computer program (1220a, 1220b) according to claim 30, and a computer readable storage medium (1230) on which the computer program is stored.
